(19) United States
(12) Patent Application Publication
(10) Pub. No.: US 2009/0026722 A1
(43) Pub. Date: Jan. 29, 2009

(54) Baggage Handling Device for Airline Check-in Counter

(75) Inventor: John Lau, Richardson, TX (US)

Correspondence Address: IP ADVISERS, 2050 NORTH PLANO ROAD, SUITE 100, RICHARDSON, TX, 75082, US

(73) Assignee: MACTRONIX, INC., Richardson, TX (US)

(21) Appl. No.: 11/829,892

(22) Filed: Jul. 28, 2007

(51) Int. Cl. B62B 5/00

(52) U.S. Cl. 280/79.11

(57) ABSTRACT

A system is disclosed for a baggage handling device to be placed between a weighing platform and a conveyor system at an airline check-in counter. The baggage handling device includes a cart portion further comprising a box frame, a set of wheels, a set of rollers, a latch mechanism and a set of handle rods, and a rail portion further comprising a rectangular frame with a set of rails and two sets of unlatch mechanisms. The set of wheels is aligned with and placed above the set of rails such that the cart portion moves along the rail portion. The latch mechanism is provided to facilitate a locked position to allow safe loading of baggage onto the cart portion.

### BACKGROUND

The present invention relates generally to a baggage handling device, and more particularly to a system of cart-like device for use at the airline baggage check-in area for transporting baggage from a weighing platform to a conveyor system used for delivering the baggage to a loading area without the need for additional lifting to be performed by check-in attendants.

In the airline industry, it is standard practice for airline customers to check-in their baggage at a designated airline check-in counter before boarding. During baggage check-in procedures, customers are asked to place the baggage they would like to check-in onto a weighing platform, typically one at a time, where the baggage will be weighed and tagged. The weighing platform is typically a scale that determines the weight of the baggage. Each baggage is then loaded onto a conveyor system that delivers such baggage to a loading area, where the baggage is then organized and loaded onto the plane by airline employees or by other mechanical means. For many of the newer airports, the weighing platforms used for weighing the baggage are often coupled with or a part of a large conveyor system wherein once a baggage is ready to be delivered to the loading area, the check-in attendant can simply press a button and have the baggage transferred, mechanically and without any further substantial human labor, directly from the weighing platform to the conveyor system, which delivers the baggage to the loading area.

However, there are still a large number of older airport terminals in use today that utilize older systems, in which the weighing platforms at the check-in counters are physically separate from the conveyor system. Due to this physical separation between the weighing platform and the conveyor system, the check-in attendant or an airline employee may be required to manually lift every baggage across said physical separation. Repetitions over a work shift may cause not only fatigue to the employee during such work shift, but also, more seriously, long term health issues such as back and shoulder injuries. Injuries to an airline employee can translate into additional overhead expenses such as workmen compensation claims and paid leave expenses due to work-related injuries.

It is thus desirable for the airline industry to design and implement a system that can help to minimize the amount of lifting required by the check-in attendants at the check-in areas of older airports where the weighing platform is physically separate from the conveyor system.

### SUMMARY

In view of the foregoing, this invention provides a baggage handling device that is designed to transfer baggage from a weighing platform at a check-in counter to a conveyor system used for delivering the baggage to a loading area without the need for additional lifting to be performed by a check-in attendant.

In one embodiment, a baggage handling device comprises a cart portion and a rail portion, to be placed between a weighing platform and a conveyor system at an airline check-in counter. The cart portion further comprises a box frame, a set of wheels, a set of rollers, a latch mechanism and a set of handle rods, while the rail portion further comprises a rectangular frame further comprising a set of rails, and two sets of unlatch mechanisms. In a preferred embodiment, there are 13 rollers, each having a diameter of approximately 2 inches, along a cart portion length of approximately 28 inches. The set of wheels is aligned with and placed above the set of rails such that the set of wheels rotates forward and backward substantially along the length of the set of rails, and such that the cart portion moves along the rail portion. Furthermore, the latch mechanism facilitates a locked position, while the two sets of unlatch mechanisms facilitates an unlocked position. When the locked position is facilitated, a gap between the cart portion and the conveyor system provides a path for the check-in attendants to move between various check-in counters without having to hurdle over the cart portion. When the unlocked position is facilitated, the cart portion is free to move along the rail portion, including helping to transfer baggage from one end of the rail portion, typically the end that is closest to the weighing platform, to another end of the rail portion, typically the end that is closest to the conveyor system.

Because the length of the rail portion is designed to be longer than the length of the cart portion, which is designed to hold and carry a typical large-size baggage, the cart portion should not take up the entire physical separation between the weighing platform and the conveyor belt. The difference between the length of the cart portion and the length of the rail portion provides a gap with which check-in attendants would be able to move easily between various check-in counters without having to hurdle over the cart portion.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A illustrates a top view of a baggage check-in area within an airport.

FIG. 1B illustrates a top view of a baggage check-in area implemented with a conventional system where an auxiliary portable conveyor is placed across a physical separation between a weighing platform and a main conveyor system.

FIG. 2 illustrates a top view of a baggage check-in area implemented with a baggage handling device in accordance with one embodiment of the present invention.

FIG. 3A illustrates a perspective view of a cart portion of the baggage handling device in accordance with one embodiment of the present invention.

FIG. 3B illustrates a perspective view of a rail portion of the baggage handling device in accordance with one embodiment of the present invention.

FIG. 3C illustrates a sectional view of the latch and unlatch mechanisms implemented within the baggage handling device in accordance with one embodiment of the present invention.

FIG. 3D illustrates a perspective view of the assembled baggage handling device where a cart portion is positioned above a rail portion in accordance with one embodiment of the present invention.

### DESCRIPTION

The following will provide a detailed description of the proposed system of a baggage handling device that is designed to be implemented at airline check-in counter to move baggage from a weighing platform to a main conveyor system used for delivering the baggage to a loading area without the need for substantial additional lifting to be performed by check-in attendants. Reference will now be made to the drawings to describe presently preferred embodiments of the invention. It is to be understood that the drawings are diagrammatic and schematic representations of the presently preferred embodiments, and are not limiting of the present invention, nor are they necessarily drawn to scale.

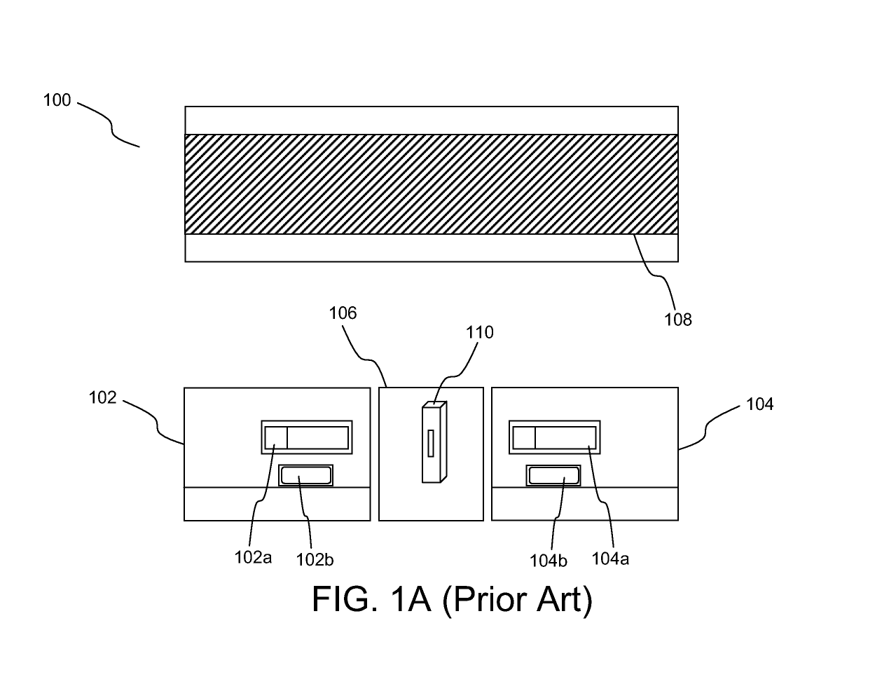

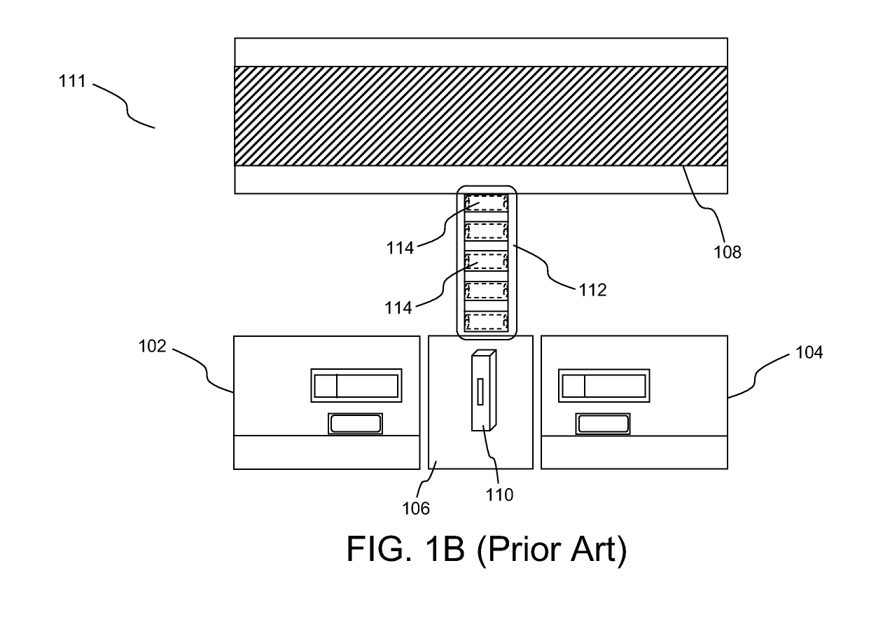

FIG. 1A illustrates a top view of a baggage check-in area 100 within an older airport where a weighing platform is physically separate from a main conveyor system. The baggage check-in area 100 comprises check-in counters 102 and 104, a weighing platform 106, and a conveyor system 108. The check-in counters 102 and 104 are typically, though not necessarily, equipped with computer keyboards 102a and 104aand computer screens 102b and 104b. Check-in attendants are typically positioned between the check-in counters and the conveyor system 108. In this example, the weighing platform 106 is connected to both check-in counters 102 and 104 to allow the check-in attendants from both counters to share the same weighing platform 106. During standard check-in procedures, the customers, standing on the side of the check-in counter that is opposite to the side on which the check-in attendant stands, are typically asked to place their check-in baggage onto the weighing platform 106 where their baggage will be weighed and tagged. Once the baggage check-in procedure is complete, the check-in attendants need to manually move the baggage, such as a baggage 110, from the weighing platform 106 to the conveyor system 108. The conveyor system 108 is used to deliver the baggage to a loading area where other airline workers can organize and load the baggage onto the airplane. The physical separation between the weighing platform 106 and the conveyor system 108 is necessary because the check-in attendants need space to stand behind the check-in counters 102 and 104 in order to serve the customers. Such physical separation may vary for each baggage check-in area, and the length of such separation determines how much lifting and carrying is required by check-in attendants. Typically, the physical separation is approximately three to five feet in length for smaller airports, and between four and eight feet in length for larger airports.

FIG. 1B illustrates a top view of a baggage check-in area 111, which modifies from the baggage check-in area 100 provided in FIG. 1A. In the baggage check-in area 111, a conventional auxiliary portable conveyor device 112 described in U.S. Pat. No. 5,944,169 provides a bridge-like device designed to be placed across the entire physical separation between the weighing platform 106 and the conveyor system 108. This bridge-like device allows check-in attendants to move baggage such as the baggage 110 from the weighing platform 106 to the conveyor system 108 without the need for additional lifting and carrying of the baggage. The conventional auxiliary portable conveyor device 112 is implemented with a set of rollers 114 to allow baggage to be moved by simply sliding them across the bridge-like device.

While the device 112 provides a means for moving baggage from a weighing platform to a conveyor system, it has several downsides. As an example, once set in place, the conventional auxiliary portable conveyor device 112 will completely span the physical separation between the check-in counters 102 and 104, thus making it very difficult for check-in attendants to move between check-in counters (e.g. from the check-in counter 102 to the check-in counter 104) without either removing or hurdling over the device 112. In both cases, check-in attendants may be more prone to work-related injury. As another example, the device 112 has to be custom-designed for different airports or check-in areas where their physical separations may be of varying lengths. The lack of an ergonomic design that is less injury-prone as well as the need for customized devices may be costly to airline operators.

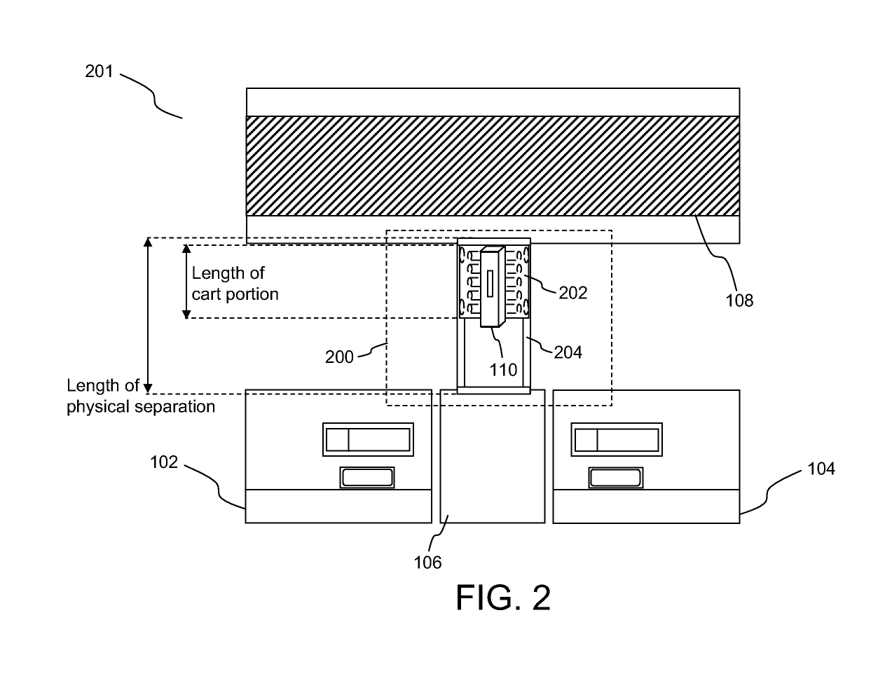

FIG. 2 illustrates a baggage check-in area 201 implemented with a baggage handling device 200 in accordance with one embodiment of the present invention. The baggage handling device 200 is a cart-like device that is designed for transferring baggage such as the baggage 110 from the weighing platform 106 to the conveyor system 108 without the need for lifting or carrying to be performed by the check-in attendants. The baggage handling device 200 comprises a cart portion 202 and a rail portion 204. The rail portion 204, stretched across the length of physical separation between the weighing platform 106 and the conveyor system 108, is secured to the ground to limit movements of the cart portion 202. For example, the rail portion 204 may be designed to limit the cart portion 202 to move only in a single dimension. The length of the rail portion 204 may vary, thus allowing the baggage handling device 200 to be installed in different baggage check-in areas where the length of the physical separation between the weighing platform and the conveyor system may vary.

The surface of the cart portion 202 is also implemented with rollers that allow smoother transfer of the baggage moving onto and off the device. In a preferred embodiment, there are 13 rollers, each having a diameter of approximately 2 inches, along a cart portion length of approximately 28 inches. During a check-in procedure, the customers are first asked to place their check-in baggage onto the weighing platform 106 where their baggage will be weighed and tagged, typically one at a time. Whenever a baggage is ready to be placed on the conveyor system 108, the cart portion 202 is moved to the end of the rail portion 204 that is closest to the weighing platform 106. The baggage is then moved, typically by sliding it, from the weighing platform 106 onto the cart portion 202. The check-in attendant can then move the cart portion 202 along the rail portion 204 towards the end of the rail portion 204 that is closest to the conveyor system 108, where the baggage is moved, typically by sliding it, from the cart portion 202 to the conveyor system 108.

The baggage handling device 200 comprises latch and unlatch mechanisms, not shown in FIG. 2, to allow the check-in attendants to lock the cart portion 202 in a locked position during loading procedures, or when the baggage handling device 200 is idle. When the cart portion 202 is in the locked position, a gap between the cart portion 202 and the conveyor system 108 provides a path for the check-in attendants to move between the check-in counters 102 and 104 without having to hurdle over the cart portion 202. While FIG. 2 shows two check-in counters, it is contemplated that the baggage handling device 200 may be implemented to serve only one check-in counter.

In this invention, the length of the rail portion 204, to be substantially similar to the length of the physical separation, is longer than the length of the cart portion 202. In the preferred embodiment of the invention, the length of the rail portion 204 is approximately six feet, while the length of the cart portion is approximately 28 inches. The difference in length provides a gap that allows check-in attendants to move between various check-in counters without having to hurdle over the cart portion 202.

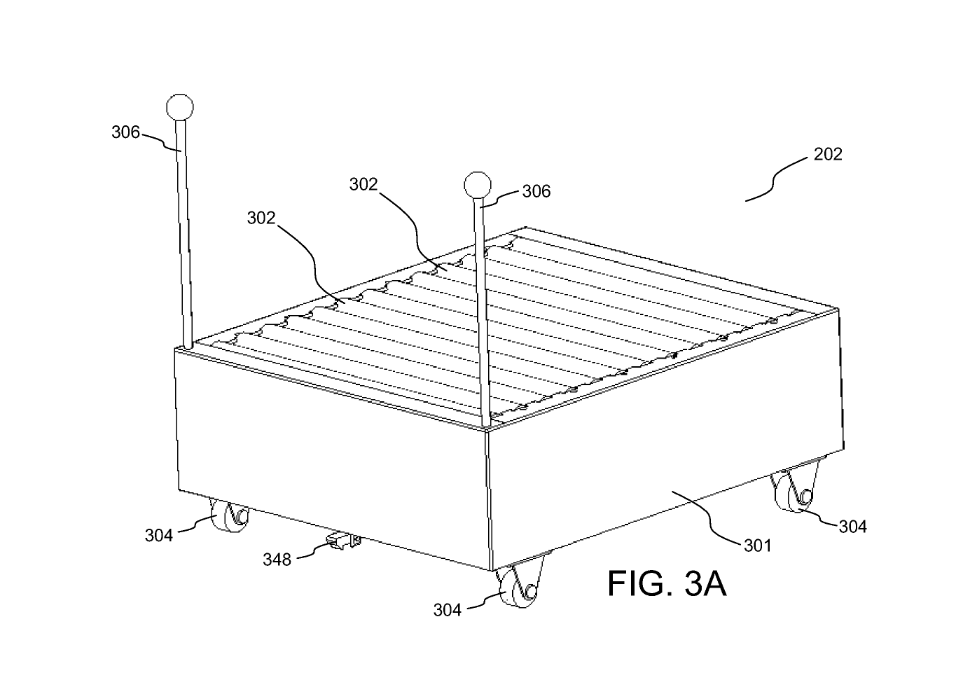

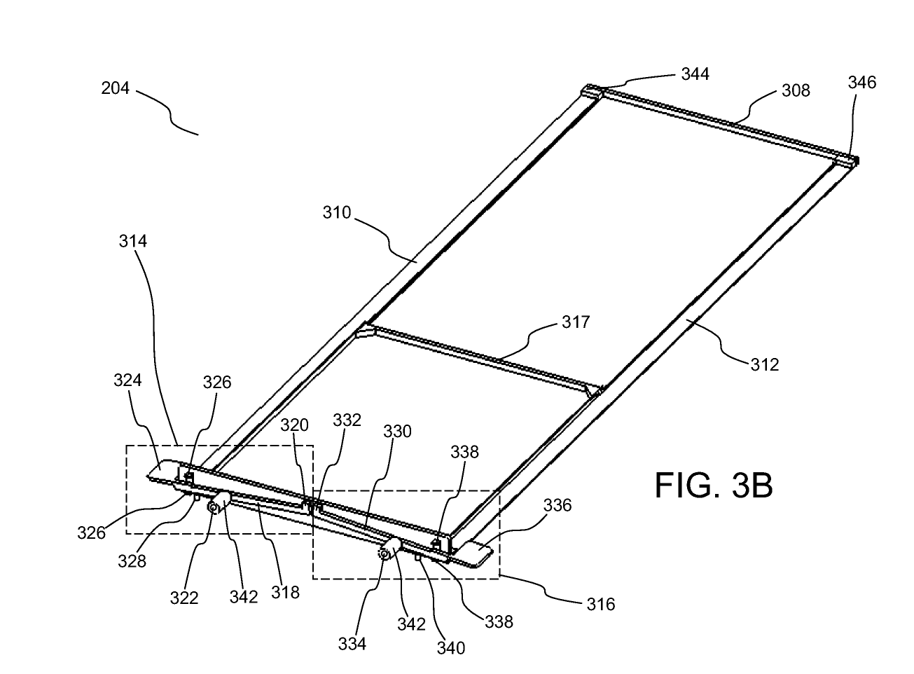

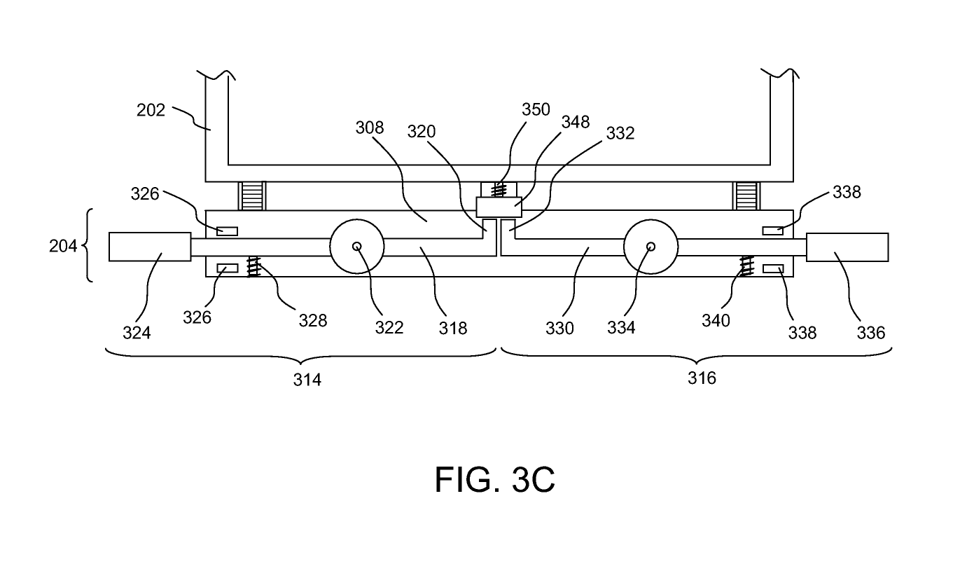

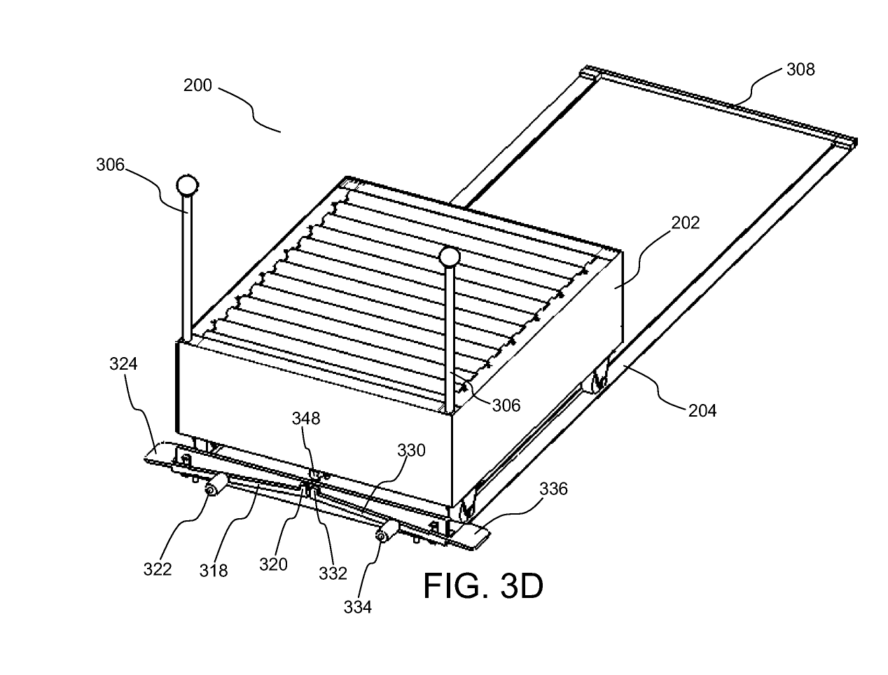

FIG. 3A illustrates a perspective view of the cart portion 202 of the baggage handling device 200 in accordance with one embodiment of the present invention. The cart portion 202 comprises a box frame 301, a set of rollers 302, at least four wheels 304 (one of which is out of sight in the perspective view illustrated), and a set of handle rods 306. The set of wheels 304 at the bottom of the box frame 301 is designed to be aligned with and placed on top of the rail portion 204 of the baggage handling device 200 to enable the cart portion 202 to be moved along the length of the rail portion 204. In one embodiment, the box frame 301, the set of rollers 302, and the four wheels 304 are made with metallic materials such as lightweight iron and aluminum. In one embodiment, the set of handle rods 306 is made with bendable materials such as plastic tubes. In another embodiment, the set of handle rods 306 is made with non-bendable materials such as extruded, non-bendable Visipak plastic tubes. In yet another embodiment, the set of handle rods 306 may also include an ergonomically-designed gripping handle for easy gripping.

The set of rollers 302, to be fixed into the box frame 301, allows the check-in attendants to easily slide each baggage onto and off the cart portion 202. Spacing between the set of rollers 302 may vary depending on the number of rollers 302 used. If a smaller number of rollers 302 are used, typically to reduce cost, additional material may be implemented to cover the spaces between each roller 302 to keep tags or other parts sticking out of the baggage from getting caught between the spaces.

The set of handle rods 306 is implemented as handles to the cart portion 202 to allow the check-in attendants to easily move the cart along the length of the rail portion 204 with minimal effort. The distance between the set of handle rods 306 is designed to be wide enough for a typical baggage to pass through. In a preferred embodiment, this distance, which is also approximately the width of the cart portion 202, is approximately 24 inches. It is notable that there are two handle rods 306 shown in this example to allow check-in attendants positioned at both sides of the cart portion 202 to utilize the baggage handling device 200. It is contemplated that different heights for the set of handle rods 306 may be designed and implemented for different setups, although it is preferred that such height is approximately three to four feet, as measured from the top of the set of handle rods 306 to the ground, on which the rail portion 204 sits.

The bottom of the cart portion 202 is also implemented with a latch mechanism, which includes a hook 348 used for hooking to the front end of the rail portion 204 during a loading procedure, or when the baggage handling device 200 is in idle position.

FIG. 3B illustrates a perspective view of the rail portion 204 of the baggage handling device 200 in accordance with one embodiment of the present invention. The rail portion 204 comprises a rectangular frame 308 comprising at least a set of rails 310 and 312, and two sets of unlatch mechanisms 314 and 316. Optionally, the rail portion 204 may include a set of stoppers 344 and 346, and a cross bar 317 for maintaining the rigidity of the rectangular frame 308.

The unlatch mechanisms 314 and 316, used for releasing the cart portion 202 from a locked position, are mirror images of each other and are placed in symmetrical position at the front end of the rail portion 204. The front end of the rail portion 204 is defined as the end of the rail portion 204 closest to the weighing platform of the check-in area. Two separate sets of unlatch mechanisms 314 and 316 are implemented to allow check-in attendants on both sides of the rail portion 204 to utilize the baggage handling device 200. The unlatch mechanisms 314 comprises a pivot arm 318, a lever wedge 320, a pivot pin 322, a foot paddle 324, a set of limiters 326, and a spring 328, while the unlatch mechanism 316 comprises a pivot arm 330, a lever wedge 332, a pivot pin 334, a foot paddle 336, a set of limiters 338, and a spring 340.

The pivot pins 322 and 334, partially covered by plastic caps 342 in FIG. 3B, are simply bolts or screws that are inserted through the pivot arms 318 and 330 and into the front end of the rail portion 204 to create pivot points for the pivot arms 318 and 330. The pivot arms 318 and 330 are designed to pivot according to the axis formed at the pivot pins 322 and 334. The plastic caps 342 covering the pivot pins 322 and 334 are designed to protect the pivot pins 322 and 334 as well as to act as a spacing bumper between the rail portion 204 of the baggage handling device 200 and the weighing platform of the baggage check-in area. Detailed descriptions for the operation of the unlatch mechanisms 314 and 316 are provided the description of FIG. 3C.

The width between the set of rails 310 and 312 is designed to substantially match the width between the set of wheels 304 of the cart portion 202 such that the set of wheels 304 rotates forward and backward along the length of the set of rails 310 and 312. In a preferred embodiment, the inner edges of the set of rails 310 and 312 are designed to protrude from the set of rails 310 and 312 to provide a wall effect, whereby the set of wheels 304 is forced to remain on top of the set of rails 310 and 312 during operation by limiting the set of wheels 304 to travel no further than the inner edges. It is contemplated that the inner edges of the set of rails 310 and 312 may be shorter at the back end of the rail portion 204, defined as the end of the rail portion 204 closest to the conveyor system, in order to allow the check-in attendants to walk across the rail portion 204 without much interference when the cart portion 202 is moved towards the front end of the rail portion 204, in a locked or idle position. It is further contemplated that an optional extension mechanism to vary the length of the set of rails 310 and 312 may be implemented to accommodate different physical separation between the weighing platform and the conveyor system. For example, in the optional extension mechanism, each piece in the set of rails comprises two separate rail elements, one substantially on top of or next to the other. The two separate rail elements include grooves or grooved tracks such that a tightening device, such as a screw, may be applied through such grooves or grooved tracks, across both rail elements. By applying the tightening device in different grooves or in different positions in the grooved tracks, the total length of each piece in the set of rails, defined as the end-to-end length of the combination of the rail elements, may be extended or retracted, depending on the physical separation between the weighing platform and the conveyor system.

At the back end of the rail portion 204, the stoppers 344 and 346 are optionally implemented to limit the movement of the set of wheels 304 of the cart portion 202, thereby ensuring that the cart portion 202 stays well inside the rectangular frame 308 and does not ram into and damage the conveyor system.

FIG. 3C illustrates a sectional view of the latch and unlatch mechanisms implemented within the baggage handling device 200 in accordance with one embodiment of the present invention. In additional to the unlatch mechanisms 314 and 316 discussed in FIG. 3B, FIG. 3C includes a latch mechanism, attached to the bottom of the cart portion 202, comprising the hook 348 and a coil spring 350. The hook 348, with a wedged front section as shown in FIG. 3A, is designed to slide past and catch the rectangular frame 308 at the front end of the rail portion 204. The coil spring 350 is used to keep the hook 348 at a down-position or latching position, whereby the hook 348 catches the rectangular frame 308 at the front end of the rail portion 204. To unlatch the hook 348 from the rectangular frame 308, the lever wedge 320 or 332 can be used to push up against the hook 348, thus lifting it to an up-position, where the hook 348 is higher than the height of the rectangular frame 308, such that it no longer catches onto the rectangular frame 308.

During latching operation, the unlatch mechanisms 314 and 316 are unused. The check-in attendant simply needs to use the handle rods 306, not shown in the figure, to move the cart portion 202 towards the front end of the rail portion 204 until he or she hears a crisp clicking sound confirming that the hook 348 has latched onto the rectangular frame 308 at the front end of the rail portion 204.

During unlatching operation, the check-in attendant, on either side of the rail portion 204, can step on the foot paddle 324 or 336 to activate the unlatch mechanisms 314 or 316. In an example scenario where a check-in attendant steps on the foot paddle 324, the pivot arm 318, which has one end attached directly to the foot paddle 324, will pivot according to the axis formed at the pivot pin 322. This results in the lever wedge 320, which is attached to the other end of the pivot arm 318, to move into an up-position, thus applying an upward force on the hook 348. This upward force will lift the hook 348, eventually high enough to clear the hook 348 from the rectangular frame 308. At this point, an unlocked position is facilitated, and the check-in attendant can simply move the cart portion 202 away by using the handle rods 306, which are not shown. Once the cart portion 202 is released from its locked position, which is defined as the hook 348 catching the rectangular frame 308, the check-in attendant can release the foot paddle 324, and the spring 328 will return the pivot arm 318 to an original position where the lever wedge 320 is at a down-position and the foot paddle 324 is at an up-position. In another example scenario, the pivot arm 330, the lever wedge 332, the pivot pin 334, the foot paddle 336, the set of limiters 338, and the spring 340 perform substantially the same functions as the pivot arm 318, the lever wedge 320, the pivot pin 322, the foot paddle 324, the set of limiters 326, and the spring 328, respectively. It is notable that the sets of limiters 326 and 338 are used to limit the movements of the pivot arms 318 and 330, respectively, such as to not allow the foot paddles 324 and 336, respectively, to reach too low where it may touch the ground, and such as to limit the movements of the lever wedges 320 and 332, respectively, to just be able to unlatch the hook 348 from the rectangular frame 308.

FIG. 3D illustrates a perspective view of an assembled version of the baggage handling device 200 where the cart portion 202 is placed above a rail portion 204 in accordance with one embodiment of the present invention. The cart portion 202 can be placed into the locked position by using the handle rods 306 to move the cart portion 202 towards the front end of the rail portion 204 until the hook 348 of the latch mechanism of the cart portion 202 catches the rectangular frame 308 at the front end of the rail portion 204. The cart portion 202 can be unlatched when a check-in attendant steps on either one of the foot paddles 324 or 336. By applying a downward force on either of the foot paddles 324 or 336, the pivot arm 318 or 330 rotates according to the axis formed by the pivot pin 322 or 334, thereby forcing the lever wedge 320 or 332 to move up, eventually lifting the hook 348 high enough to unlatch it from the rectangular frame 308. With the hook 348 lifted up, the check-in attendant can use the handle rods 306 to move the cart portion 202.

The above description of the unlatch mechanisms 314 and 316 does not, while unlikely, limit unlatching to be performed by both unlatch mechanisms 314 and 316 at the same time. Furthermore, the above description does not limit a collaborative unlatching by two check-in attendants whereby one check-in attendant unlatches by stepping onto the foot paddle on one side of the rail portion while another check-in attendant pulls the cart portion away from the front end of the rail portion by pulling a handle rod on another side of the rail portion.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A baggage handling device to be used at an airline check-in area comprising:
a cart portion comprising a box frame, a set of wheels, a set of rollers, a latch mechanism and a set of handle rods; and
a rail portion comprising a rectangular frame further comprising a set of rails, and two sets of unlatch mechanisms, the rail portion having a length that is at least longer than the length of the cart portion, wherein
the set of wheels is aligned with and placed above the set of rails such that the set of wheels rotates forward and backward substantially along the length of the set of rails, and the latch mechanism facilitates a locked position and the two sets of unlatch mechanisms facilitates an unlocked position.

2. The system of claim 1, wherein the set of rollers is fixed into the box frame and implemented on the surface of the cart portion.

3. The system of claim 1, further comprising an optional extension mechanism for varying the length of the set of rails.

4. The system of claim 1, further comprising a stopper to be coupled with each of the set of rails.

5. The system of claim 1, further comprising a cross bar to be coupled with the rectangular frame for maintaining the rectangular frame's rigidity.

6. The system of claim 1, wherein an inner edge of the set of rails protrudes from the set of rails to provide a wall effect.

7. The system of claim 1, wherein the length of the cart portion is approximately 28 inches and the length of the rail portion is approximately six feet.

8. A baggage handling device to be used at an airline check-in area comprising:
a cart portion comprising a box frame, a set of wheels, a set of rollers, a latch mechanism and a set of handle rods; and
a rail portion comprising a rectangular frame further comprising a set of rails, and two sets of unlatch mechanisms, the rail portion having a length that is at least longer than the length of the cart portion, wherein
the set of wheels is aligned with and placed above the set of rails such that the set of wheels rotates forward and backward substantially along the length of the set of rails,
the latch mechanism facilitates a locked position and the two sets of unlatch mechanisms facilitates an unlocked position, and the rail portion is placed substantially in a physical separation between a weighing platform and a conveyor system at the airline check-in counter.

9. The system of claim 8, wherein the set of rollers is fixed into the box frame and implemented on the surface of the cart portion.

10. The system of claim 8, further comprising an optional extension mechanism for varying the length of the set of rails.

11. The system of claim 8, further comprising a stopper to be coupled with each of the set of rails.

12. The system of claim 8, further comprising a cross bar to be coupled with the rectangular frame for maintaining the rectangular frame's rigidity.

13. The system of claim 8, the latch mechanism further comprising a hook for latching onto the rectangular frame and a coil spring for keeping the hook at a down-position.

14. The system of claim 13, each set of unlatch mechanism further comprising:
a pivot pin to be coupled with the rectangular frame;
a pivot arm for rotating about the pivot pin;
a lever wedge at a first end of the pivot arm;
a foot paddle at a second end of the pivot arm;
a set of limiters for restricting the movement of the pivot arm; and
a spring for returning the pivot arm to an original position, wherein
when foot paddle is stepped onto, the pivot arm rotates to lift the lever wedge, which lifts the hook high enough to unlatch the hook from the rectangular frame.

15. The system of claim 14, wherein the pivot pin is covered with a plastic cap.

16. The system of claim 8, wherein an inner edge of the set of rails is higher to provide a wall effect.

17. The system of claim 8, wherein an inner edge of the set of rails is of a varying height such that the height at the end of the set of rails closest to the conveyor system is lower than the height at the end of the set of rails closest to the weighing platform.

18. The system of claim 8, wherein the height of the set of handle rods is between three and four feet.

19. The system of claim 8, wherein the length of the cart portion is approximately 28 inches and the length of the rail portion is approximately six feet.

20. The system of claim 8, wherein the width of the cart portion is approximately 24 inches.
